(19) United States
(12) Patent Application Publication
(10) Pub. No.: US 2006/0218042 A1
(43) Pub. Date: Sep. 28, 2006

(54) Method for operating a restaurant having an electronically changeable, geographically oriented visual environment

(76) Inventor: Raynaldo Torrez Cruz, Chateaugay, NY (US)

Correspondence Address: STAINBROOK & STAINBROOK, LLP, 3558 ROUND BARN BLVD., SUITE 203, SANTA ROSA, CA, 95403, US

(21) Appl. No.: 11/195,300

(22) Filed: Aug. 1, 2005

Related U.S. Application Data
(60) Provisional application No. 60/661,147, filed on Mar. 11, 2005.

(51) Int. Cl. G06Q 30/00

(52) U.S. Cl. 705/15

(57) ABSTRACT

A method of operating a restaurant or a chain or restaurants is described whereby the geographic theme at each restaurant location is visually changeable electronically, day by day, along with the menu offered at that location, to be reflective of the foods of the geographic location selected. The visual environment is enhanced by projections of real time images of the chosen location onto display screens, positioned behind virtual windows, through which the patrons of the restaurant are exposed.

This application is based on U.S. Provisional Application No. 60/661,147, filed Mar. 11, 2005, Raynaldo T. Cruz, inventor, and incorporates herein and claims priority to the said Provisional Application.

### BACKGROUND OF THE INVENTION

1. Field of the Invention

This invention relates to a method of operating a restaurant or a chain of restaurants whereby the geographic theme for the visual environment of the restaurant can be electronically changed, day to day, along with the menu offered at that location, to be reflective of the foods of the geographic theme chosen. The visual environment is enhanced by projections of real time images of a selected location onto display screens which are positioned behind virtual windows, through which they can be viewed by the patrons of the restaurant.

2. Description of the Related Art

In the past, restaurants have presented varied menus and manually changed décor to provide their patrons with a dining experience in imitation of a selected location. For example, on one night a restaurant may offer an Italian theme, where the menu is specific to Italian dishes. On another night, a French theme may be offered, the menu changed, and certain decorations within the restaurant replaced by decorations associated with the selected country or a particular city within that country. However, applicant is unaware of any attempt to enhance the dining experience by providing real time, windowed views of the selected country or city.

### SUMMARY OF THE INVENTION

It is an object of this invention to provide a diversified city or country atmosphere that can be easily changed on a daily basis to provide for a new dining experience each day of the week.

By way of this invention, a dining room experience is provided in which at least one, if not more walls of the dining room are provided with virtual windows. On the other side of the wall, behind the virtual windows is a display screen. This may be comprise of one or more flat-panel plasma or TFT screens, cathode ray tube screens, rear projection type screens, or screens upon which an image can be projected from the screen. The exact type of screen is not critical, so long as video images can be displayed, though the higher the image definition, the more realistic looking will be the created image.

The type of window simulated may also be varied. It can be presented as a large or small picture window, bay window, paneled window, sash, or side opening window, etc. The size of the window is not critical, though the display screen behind the window opening should be at least as large as the opening, if not larger. In one embodiment, the window, be it a bay or picture window comprises an entire wall of the dining room, to thus provide the most dramatic possible view of the selected location.

Projected on the one or more screens is a real time, extended video recording taken from one or more stationary cameras located at a selected remote location, the recording covering a time span of at least several hours. The recorded video can be of a street corner, taken from across the street, the recording beginning at a predetermined time, such as an hour before sunset and continuing into the night. The length of the video recording is not critical so long as it is long enough to span the hours of operation of the restaurant, from a time prior to the restaurant dining room being opened until after closing time.

In addition to the electronic image, an audio track at the camera local can be recorded simultaneously. The sound pick-up may be situated behind a window or wall at the location of the camera. In this way, only the most pronounced street noises are picked up through the walls/windows at the filming location. In another embodiment, where the remote setting may be an outdoor café, the sound pick-up can be placed outside, at the camera position. In this embodiment, all ambient noises will be recorded, providing a true “being there” auditory experience. In such case, the audio track can be previewed before play, in order to edit out offensive speech, as well as particularly loud street noises that may be annoying.

In the one embodiment, where a single window, be it a bay or picture window will comprise an entire wall of the dining room, the video screen (or screens) will likewise span the room. If the wall is partitioned into several distinct window areas, the same continuous video screen can be used. In this way, only one image need be projected.

Alternatively, a separate video screen can be provided for each window. In this case, separate video programs taken with separate cameras stationed at corresponding locations may be employed. Where the dining room is configured as a corner room, the images associated with the side windows may be taken from another camera appropriately positioned at the remote location. In this embodiment, dining patrons located any one of the different windows would view a somewhat different image, depending upon their location within the dining room.

The effect presented is to transport the patron to the location where the video was recorded. Thus, if a Paris panorama were recorded, a patron in the restaurant would see that view through the virtual windows of the restaurant, in real time. Where the recording was of a Paris street scene, the restaurant patron would experience that street as if they were there, in real time. By real time, it is meant that the video playback time is scheduled such that the time at which the video is taken, image per image, is the time at which it is played back, no matter what the time zone differences between the restaurant and the selected location. Thus, in the Paris example, if the local time at a restaurant in San Francisco were 5:30 PM PDT, the displayed scene would be the image captured at that same time, 5:30 pm, in Paris.

In the operation of the restaurant, being able to change the electronically presented image, and thus the “virtual location” of the dining room, provides new and unique opportunities for changing dining themes, as will be more fully explained in the detailed description which follows.

### BRIEF DESCRIPTION OF THE DRAWINGS

So that the manner in which the above recited features of the present invention can be understood in detail, a more particular description of the invention, briefly summarized above, may be had by reference to various embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1a and 1b are renditions of a dining room according to this invention where an entire wall is configured as a virtual window.

FIG. 2 is a plan view of an exemplary restaurant layout, including a reception area, an anteroom, and a dining room, the reception room including electronically changeable posters, and signs, the dining room including additional display screens, along with a computer system used to store and play the stored images.

FIG. 3 is an illustration of a networked restaurant chain, whereby dispersed sites are linked to a central server, providing access to a video library of selected geographic locations.

### DETAILED DESCRIPTION

By way of this invention a system and method is provided for creating a diversified city or country atmosphere that can be changed daily electronically, to afford a new dining experience every day of the week. Thus, a restaurant, or each restaurant of a chain, may change its virtual location to provide a worldwide dining experience regardless of its actual location. Diners are thus able to experience the ambience of US and foreign cities, and other geographic locations or concept environments without having to travel outside their immediate locale.

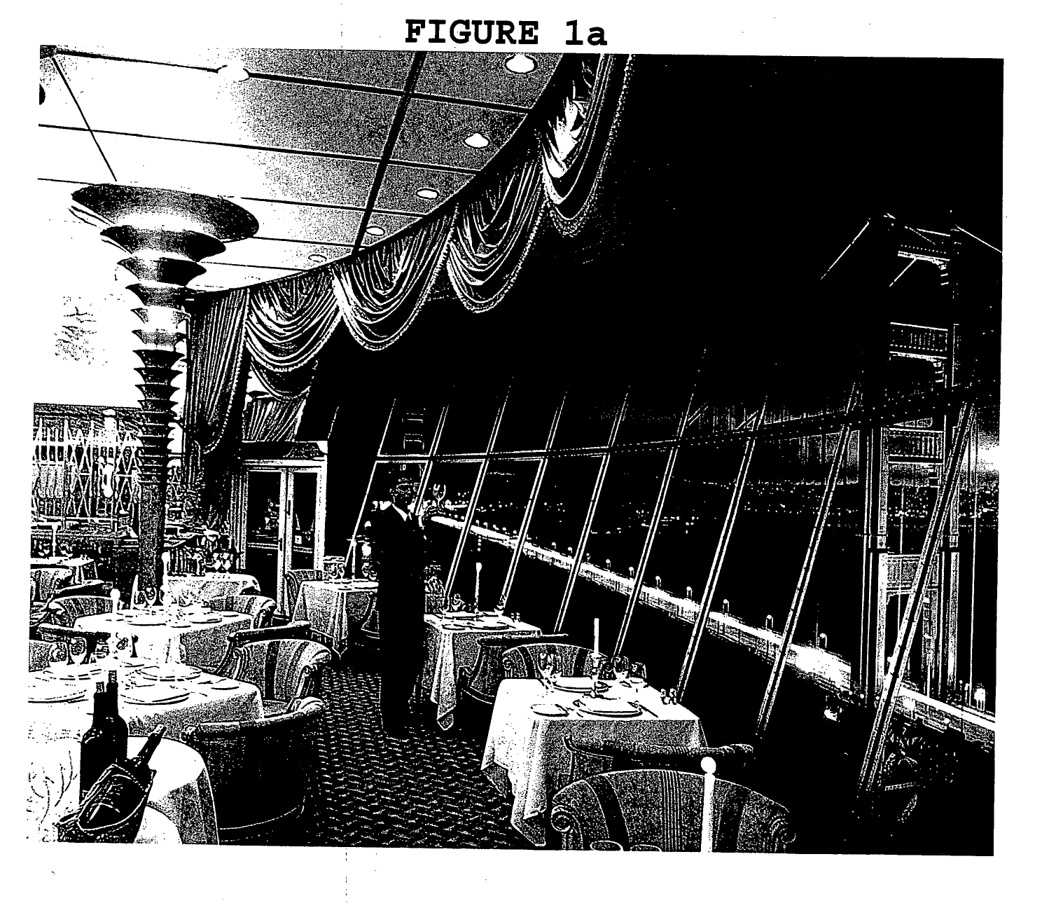

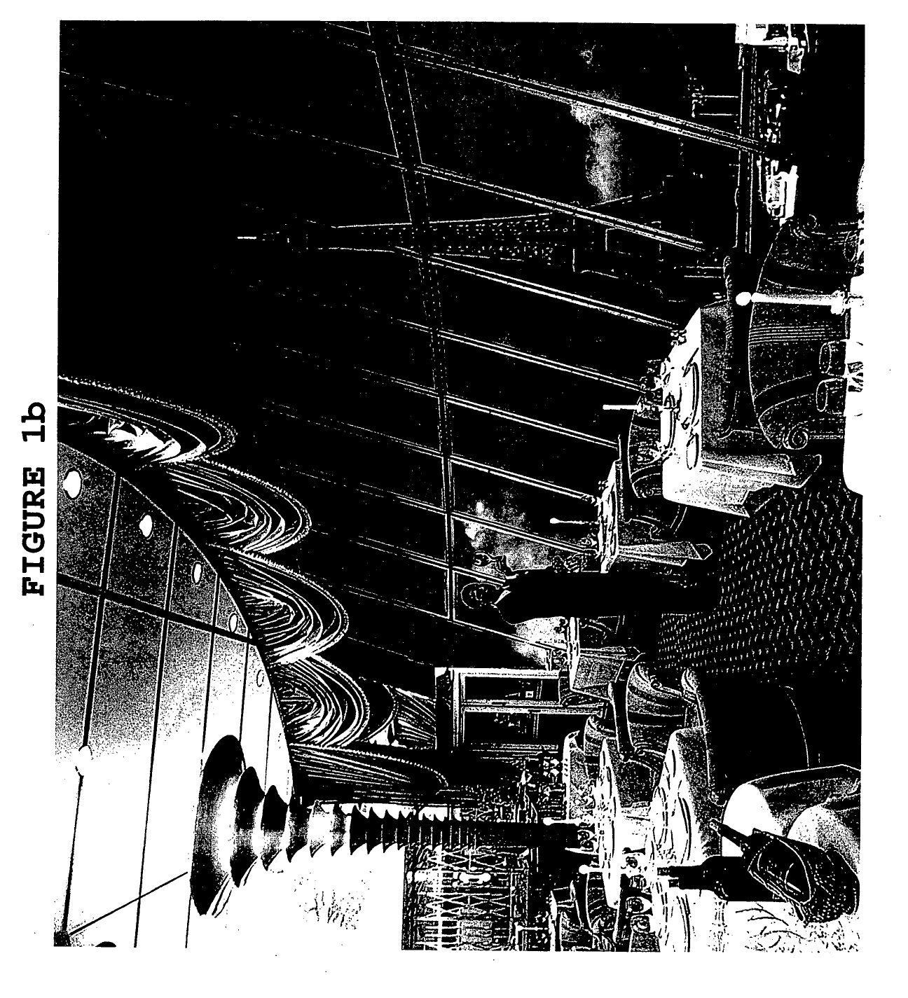

This switching of geographic environments is achieved through the use of virtual windows, having screens behind them and onto which images of the selected local are created or projected, to provide the illusion of being in a room at that location. The window or windows may be of any size and shape. As illustrated in FIG. 1a, the window can make up the entire wall of the dining room to provide a dramatic, encompassing view. As illustrated in the FIGS. 1a and 1b, the projected view can be changed from as desired, such as night to night, with the Golden Gate Bridge of San Francisco shown in FIG. 1a, and the projection view changed in FIG. 1b to a street scene of the Eiffel Tower in Paris. In embodiments not illustrated, the window can comprise a plurality of windows selectively positioned along a wall. The type of window, whether sash, casement, bay, or other design is not critical, its appearance being a matter of restaurant design choice. So too is the use of glass within the window, though having glass is preferred as it provides a more realistic window presentation.

In one embodiment the virtual window can actually comprise a wall of flat panel display screens mounted one next to the other in the manner shown in FIGS. 1a and 1b. In this embodiment, the fames of the display screens define the window frames, and the glass of the display screen comprises the glass of the virtual window. In another embodiment, the virtual window is constructed as a traditional window, with a display screen onto which an image of a geographic location can be displayed positioned behind the window.

The type of display screen selected is not critical, though screens capable of producing high definition images are to be preferred. Typical of display screens which may be employed are plasma, TFT, rear projection, and CRT screens. Projection means associated with each type of display screen is used to convert the stored electronic image information into an image on the screen. Also suitable are movie type screens for receiving an image from a front based projector. A disadvantage of the latter, however is that the projector itself, necessarily located within the dining room, should be concealed from view, to better maintain the illusion of looking through a real window at a scene remote from the dining room location.

In the first embodiment where the screen is the window, the size of the display screens is not critical. Where the display screen sits behind a window, the screen should be at least as large as the opening of the window behind which it sits. In this embodiment, the size and placement of the screen behind the window should be such that restaurant patrons, no matter where they are situated within the dining room, are unable to view the edge of the display screen or screens. In the embodiment employing multiple windows on a single wall, this effect can be achieved by providing a display screen which spans beyond the window zone area of the wall. In another embodiment, the width of the display screen can be selected or configured to extend from a few inches to at least a foot beyond the border of the window in any direction.

The displacement of the screen behind the window is likewise a factor to take into consideration when selecting the screen size for a particular window. In the embodiment of FIGS. 1a and 1b, the screen is the window. In the other embodiment, the screen may be positioned up against the window or from several inches to over a foot behind it. The further back the screen is positioned, the larger the screen must be, but the more realistic the visual affect.

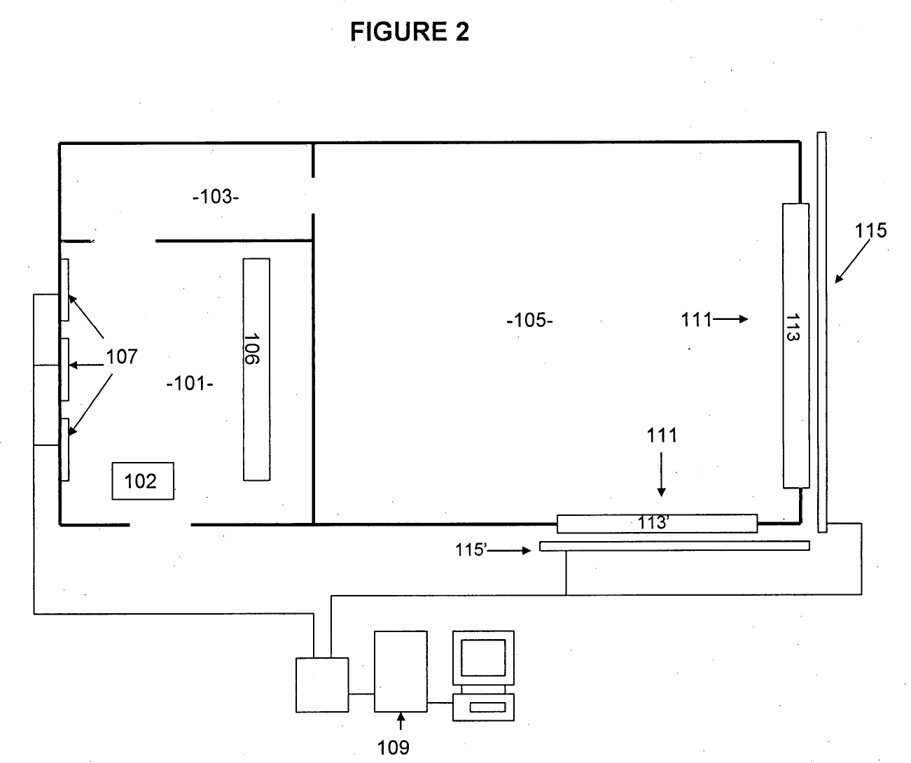

In one embodiment, a virtual window or windows can be placed on more than one wall, as illustrated in FIG. 2, where a second virtual window is positioned at one corner of the room, disposed 90° to the first window. To maintain the visual illusion with such an arrangement, the recorded image can be extended and wrapped around the corner, such that the extension of the image is displayed on the second wall's window(s). In another embodiment, a second recording can be made to create a second displayable image, the second recording created using an additional camera placed relative to the first camera at the remote location, to replicate the views relative to the positions of the windows at the restaurant. When played, the displayed images are matched with respect to the time they were recorded. This can be accomplished by time coding the recordings, so they can be synchronized during playback.

It should be appreciated that in other embodiments, any number of virtual windows can be provided on any number of walls of the dining room. The considerations described above with reference to the size and placement of the display screens will be equally applicable, no matter how many windows there are, and no matter on how many walls they are deployed. The more extensive the deployment, however, the more likely will be the requirement to further extend the displayed image, or to employ additional cameras/video recorders to provide images taken from corresponding vantages.

By way of the methods of this invention, a video library is created which can be provided to a restaurant in the form of images electronically recorded on storage mediums such as tapes, individual floppy or video disks, read only, flash memory or the like, or maintained at a central server for access by one or more restaurants. In creating of the video library, the camera, preferably a digital camera, is placed at a single, stationary point at the chosen geographic location, and a multiple-hour long video image created. By way of illustration, to create the virtual illusion of being at a restaurant at a plaza in such a city as for example Seville, Spain, a camera is set up at or in a building or on a tripod at a selected sidewalk location looking out at the plaza, and the video image electronically recorded.

In the usual case, the focus of dining experience will be at dinnertime. Accordingly, the provided recordings preferably span the hours of, for example, 4 pm local time through 2:00 am of the next day. It is to be appreciated that provided prerecorded videos can be of any length, up to and including 24 hours. In one alternative, a continuous, live video feed is provided, where the captured image changes moment to moment, day to day. The captured image can be shown on a taped delay basis, so that the time local where the remote video is being recorded corresponds to the local time at the restaurant where the video is being played.

In the former case where the camera records the image for local storage on a transferable analog or digital medium, such as a tape or DVD, the advantage is provided that it is relatively easy to edit the recorded images so that anything which might be objectionable to the dining patrons can be removed. In the case of a continuous feed the advantage is provided that the scene depicted is a true picture of the daily view from the remote location, complete with its changing weather, lighting, etc. Thus, where the remote location might be a small village in England, where it is sunny one day, and raining the next, the viewed image at the local restaurant would be reflective of the current conditions of the day at the remote location. A disadvantage of continuous video feed is the requirement of constant oversight and maintenance of the cameras at the various locations being filmed. Offsetting this is the ability to provide real time views of the selected remote location, which changes with the weather and the seasons. Whether or not to provide recorded images, or a continuous video feed to the local restaurants is not critical to the methods of restaurant operation of this invention, being rather a decision that can be made on a case by case basis by the provider of the electronically changeable video dining room service.

In another embodiment of this invention, an audio track can be recorded along with the visual recording, for play-back at the local restaurant location. By adding the dimension of audio to the video, the illusion of place is further heightened. For example, if in the captured video scene, a motor scooter were to move across the screen, the sound of the scooter would be played with the accompanying projected image. As with the pre recorded video image, the audio image may be edited to delete unwanted sounds, or conversations captured by the audio pick-up. In another embodiment, radio station programming local to the remote site can be recorded and played back, synchronized in time to that of the local restaurant.

In an embodiment of this invention, dining patrons enter a restaurant into a reception area 101, such as illustrated in FIG. 2. There, they are greeted by a host at reception station 102, reservations taken, and there they can be accommodated until seated in the dining room 105. To introduce the patrons to the day's geographic location, video displays 107 can be placed on the walls about the room, these displays provided in addition to other visual clues and decorations. Electronically imaged on displays 107 are posters local to the day's geographic location, or dynamic billboards announcing “local” events. Other display options include delayed-feed television programming “local” to the featured location, and the like. As shown in FIG. 2, these electronic bulletin boards, and posters 107 can be linked in to the same file server 109 that provides the electronic images for the virtual windows 111 of the dining room. The virtual windows, as illustrated, comprise the window openings 113 and 113′ themselves, behind which are positioned display screens 115 and 115′.

With reference to FIG. 2, an antechamber 103 may also be provided, space permitting, antechamber 103 connecting reception area 101 to dining room 105, and providing a visual barrier to the dining room, such that the dining patron is not exposed to the visual images within the dining room until they enter that room. Thus, anteroom 103 serves as a transition space preventing the observance of the dining room from the reception area.

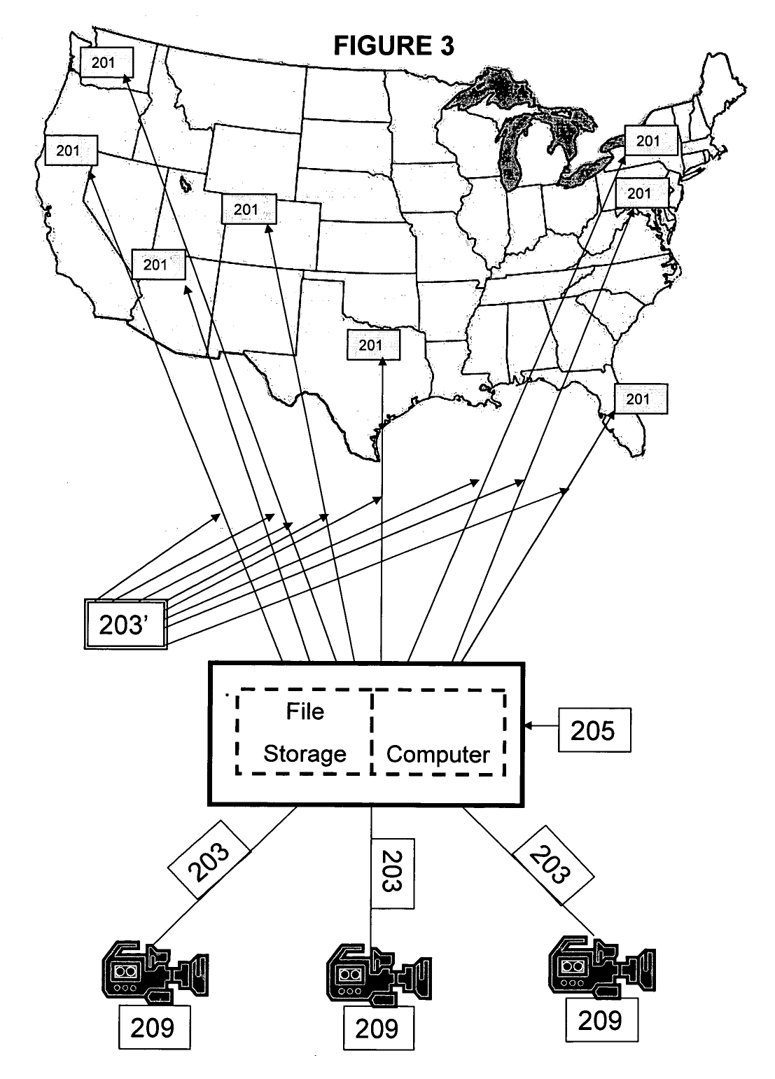

FIG. 3 is a conceptualization of a restaurant chain in which several restaurants 201 are subscribers to virtual location programming. Each restaurant includes a dining room area having at least one virtual window. Video programming is provided either in the form of prerecorded tapes or video disks, thus creating a local library of remote geographic locations, or it can be provided through a subscriber network connected by internet, or intranet links 203′, be they wire, optical or wireless, wherein the local restaurant on any given day may select from any number of remote geographic videos maintained at a central server 205. Through server 205, the playback of the selected video can be synchronized to the local time of a subscriber such that the time of capture of the image depicted in the video corresponds with the time it is being displayed at the restaurant, no matter where that restaurant may be located. In the case of a live video, and perhaps audio feed, the images captured by remote cameras 209, can be similarly linked via connections 203 to the central file server 205.

Having so far described the systems use to create the virtual environment, the operation of a virtual location restaurant or chain of such restaurants will now be described.

In the usual case, the interior of the restaurant will consist of two separate environments. Diners entering the restaurant are first greeted by receiving staff. The decision as to whether or not to offer dining by reservation or to include drop in diners would be one made by the individual restaurant or franchisee. Customers are then escorted into the reception room. Those with reservations are allowed time to peruse the visual offerings of this room. Those without reservations could be provided refreshment such as from a bar 106 during their wait.

The reception area can be decorated in an alternating fashion that compliments the city location of the day. The first visual effect to be noticed by a patron as they enter are the bill boards depicting noteworthy attractions and aspects of interest relating to the city of the day. For example, for the City of Chicago, displayed might be pictures of the Sears Towers, Wrigley Field, Soldier Field, Comiskey Park, the EL, etc. Additional information might include city history anecdotes and state related information. The idea is to provide an informational base intended to approximate the experience gained from traveling to this city as well as providing an engaging waiting area.

Entry into the dining area can be through closed doors and a dimly lit anteroom that prevents viewing from the reception area. Diners are escorted into a large room dominated by the windows looking out into a cityscape. The room is designed to allow views from all seats. Tables are set back from the windows to allow for perceived depth of vision of vista. The view captures a city scene or vista recorded to reflect one hour before sunset through 0200 a.m.

The restaurant can be sized, though size is not critical, to accommodate from 50 to as many as 300 customers. Occupancy would vary dependent upon location, projected customer volume and available room size. Cloth covered tables can be embellished with the city art, floral centerpieces and lit candles. Chairs can be upholstered and tables varied in place settings from two to eight. The windows can be dressed with drapes. The ceilings can be enhanced with chandeliers. Music can be piped in, the play selection associated with the city to be experienced.

In a preferred embodiment, the dining area is designed to overwhelm the patron upon entry, with the view from large windows. The recording being displayed can be of a panoramic setting 1800 wide and extending from floor to ceiling, so designed for everyone in the dining room to enjoy equally. Inside the dining area, whether one or more projections are being used, wherever diners sit, they will be observing that particular angle in a real-time setting. The bay windows are designed to hide the screen but enhance the senses for the setting.

The menu can remain the same throughout the week as far as basic offerings are concerned. However, each day specials can be offered that correspond to what someone in the particular city of the day would normally be exposed to or be familiar with. When possible, wine, beers, and other drinks associated with the selected city or regional local would be offered on the menu.

Every day, something changes. For example, Monday in Chicago, Tuesday in San Francisco, Wednesday in Seattle, and Thursday in Honolulu. Weekends could provide a foreign atmosphere with world cities (e.g. Friday in Paris and Saturday in Athens). Sunday can be for brunch. With so many cities to choose from, the continual change of cities is designed to keep the concept fresh. Diners will call to see what city is being presented that day, or on what day a certain city of their choice might be offered.

By providing for the electronic control of the visual environment, other concepts become possible. For example, each month a special event can be run to increase interest. These special events would potentially require a greater initial expenditure, but would be available for use throughout the year. With numerous alternatives, there is little chance of an event going stale. Such events, for example could include:
i) Aquarium—the bay windows are now an aquatic tank and diners are sitting in the middle of an aquarium.
ii) Space—the bay widows reflect footage taken from shuttles and the space station.
iii) City of Choice—contests to pick the “City of Your Choice”. Winner picks the city to be shown on a particular day with seating at a prime table.
iv) Ancient History—cities of the past are created from ruins and/or visual enhancement. Ancient meals and music can accompany a voyage to the past.

The concept environment allows the diner to experience a U.S. or foreign city without having to travel great distances. As diners enjoy their meal, they can see a sunset over the city vista as if they were sitting in a restaurant in that city. City building lights turn on at nightfall, planes take off from a distance, atmosphere changes (fog rolling in, storms, and the like) and traffic bustles. As the diners finish their meal and are about to leave, they are left with a feeling that they have traveled to a city hundreds or even thousands of miles away.

While the foregoing is directed to embodiments of the present invention, other and further embodiments of the invention may be devised without departing from the basic scope thereof, and the scope thereof is determined by the claims that follow.

1. A method of operating a restaurant comprising;
providing a dining area including a room having at least one wall;
providing at least one virtual window on said at least one wall, said virtual window including at least one display screen providing projection means for generating an image on said display screen;
providing a file server capable of storing a digital library of extended real time visual recordings, the server connected to said projection means to allow recordings to be displayed on said at least one display screen;
collecting a plurality of visual recordings, said recordings generated using a recorder placed at a geographic location different from the location of the restaurant;
storing said collected recordings in said file server; and,
selecting a single visual recording from the library and playing that recording such that the stored visual image is displayed onto said at least one display screen.

2. The method of claim 1 in which the local start time of the recording is selected to coincide with the local start time of the visual recording generated at the said different location from the restaurant.

3. The method of claim 1 wherein the opening in said virtual window designed to have the appearance of a window, wherein said display screen is positioned behind said window.

4. The method of claim 3 wherein the at least one wall contains a plurality of windows.

5. The method of claim 1 wherein the room has at least three walls, with openings provided in at least two of said walls, and a display screen positioned behind each of said openings.

6. The method of claim 4 wherein the at least one wall is a virtual window, and the virtual window includes a plurality of display screens.

7. The method of claim 1 wherein a different visual program is selected for each night of the week.

8. The method of claim 1 wherein several restaurants are connected to the same file server, whereby any one restaurant may access any one of the visual recordings for local projection at that restaurant, the start time of the selected visual recording keyed to the local time of the selecting restaurant.

9. The method of claim 1 wherein the menu of the restaurant is selected to reflect the cuisine of the location of the selected visual recording.

10. The method of claim 1, wherein the restaurant further includes a reception area separate from the dining area.

11. The method of claim 10 wherein the reception area includes video display screens upon which are projected images local to the geographic area of the selected visual image program.

12. The method of claim 11 wherein the projected images are stored in the computer server, and comprise electronic posters.

13. The method of claim 12 wherein the posters are selected from the group including travel posters, event announcement posters, directional posters, and informational posters specific to the locale of the selected visual recording.

14. The method of claim 10 wherein the restaurant further includes an ante room between the reception area and the dining room to provide a transition between the two, the ante room preventing a patron in the reception area from being able to view the interior of the dining room.

15. The method of claim 1 wherein audio outlets are provided in said dining room, the audio outlets linked to a broadcast station local to that of the geographic area of the selected visual recording, played in real time if the restaurant and the location of the selected visual program are in the same time zone, and played on a time delay appropriate to the time zone differential where the location of the selected recording is in a different time zone than that of the restaurant.

16. A method for providing an electronically changeable visual setting for a dining room, the method comprising:
providing a dining room having a least one wall, said wall having a front side and a backside, the front side of said wall disposed so as to be facing into the interior of the said dining room;
providing at least one virtual window in said at least one wall, said virtual window including at least one display screen, whereby the image displayed on said screen is viewable by a patron located within said dining room;
providing a storage medium for storing at least one digital video program;
storing a digital video program in said storage medium, said stored digital video program recorded at a location remote from the location of said dining room; and,
displaying on said display screen said stored video image.

17. The method of claim 16 wherein the projected image is synchronized such that the time at which the image is played on the display screen corresponds to the time at which the image was recorded at the remote location.

18. The method of claim 16 wherein at least two digital video programs recorded at different remote locations are stored in said storage medium.

19. A method for providing an electronically changeable visual setting for a dining room, the method comprising:
providing of a dining room having a least one wall, said wall having a front side and a backside, the front side of said wall disposed so as to be facing into the interior of the said dining room;
providing of at least one window in said at least one wall;
providing at least one display screen behind said window, whereby the image displayed onto said screen is viewable by a patron located within said dining room;
providing a source of video programming; and,
displaying a video image on the said at least one display screen, based on said provided video programming.

20. A system for providing an electronically changeable virtual dining experience including:
a dining room having one or more virtual windows, said windows including at least one video screen;
a computer for controlling the delivery of stored video recordings to projecting means for creating images on said screens; and,
a file server for electronically storing a plurality of video recordings to be delivered by said computer to said at least one screen.
